(19) United States
(12) Patent Application Publication
(10) Pub. No.: US 2012/0148789 A1
(43) Pub. Date: Jun. 14, 2012

(54) AIRCRAFT STRUCTURE WITH STRUCTURAL PARTS CONNECTED BY NANOSTRUCTURE AND A METHOD FOR MAKING SAID AIRCRAFT STRUCTURE

(76) Inventors: Per Hallander, Linkoping (SE); Mikael Petersson, Linkoping (SE); Björn Weidmann, Borendberg (SE); Tommy Grankäll, Borensberg (SE); Pontus Nordin, Linkoping (SE)

(21) Appl. No.: 13/377,105

(22) PCT Filed: Jun. 11, 2009
(86) PCT No.: PCT/SE09/50718

§ 371 Date: Feb. 29, 2012

(51) Int. Cl. B32B 7/12; B32B 27/20; B29C 65/42; B32B 27/38; B82Y 30/00

(52) U.S. Cl. 428/113; 156/182; 428/413; 428/221; 428/157; 977/701

(57) ABSTRACT

An aircraft structure including structural composite parts assembled together to form the aircraft structure. A bonding interlayer material bonds the structural composite parts to each other. The bonding interlayer material includes a nanostructure enhanced material. A method of producing an aircraft structure of assembled structural composite parts, being cured or semi-cured before assembly.

### TECHNICAL FIELD

The present invention relates to an aircraft structure comprising structural composite parts assembled together to form said aircraft structure according to the preamble of claim 1. The present invention also relates to a method according to claim 9.

### BACKGROUND ART

The aircraft structure is defined as a specific structure of an aircraft, such as a wing, a fuselage, a rudder, a flap, an aileron, a fin, a tailplane etc. The aircraft structure consists of at least two assembled, and bond together, two- or three-dimensional structural composite parts.

Aircraft structures (also called integrated monolithic structures) are assembled together for building an aircraft. The aircraft structure is composed of the structural composite parts, such as wing beams, shells, radius fillers, wing ribs, bulkheads, nose cone shell, frames, web stiffeners etc. The structural composite parts are formed and cured together with an adhesive film between adjacent structural composite parts for achieving a bonding there between. The structural composite parts will thus, bonded together, constitute an aircraft structure for use in the aircraft. Also rivets, screws have traditionally been used for bonding the structural composite parts together.

The structural composite parts is usually separately formed (e.g. hot drape forming or mechanical forming) into structural composite parts. They are thereafter assembled together to form the aircraft structure. The structural composite parts are assembled together by means of the bonding interlayer material, i.e. an adhesive. The adhesive can be a melt-bondable adhesive resin such as an epoxy.

However, there is a desire to reduce the air craft weight since it is important to save fuel for propelling the aircrafts, making the aircraft more environmental friendly. There is thus desirably to increase the strength of the aircraft structures. By increasing the strength, the thickness of the structural composite parts of the aircraft structures can be reduced and thereby the total weight of the aircraft can be reduced.

The structural composite part of the aircraft structure is thus defined in this application as a specific three-dimensional structural composite part being used together with at least another specific three-dimensional structural composite part for building the aircraft structure.

For example, a wing (aircraft structure) may comprise assembled upper and lower shells, beams, wing ribs (three-dimensional structural composite parts). For example, an aileron (aircraft structure) may comprise together assembled shells, prolonged conic formed hollow beams, radius fillers (three-dimensional structural composite parts).

The structural composite part can be made of a stack of pre-preg plies (fibre layers impregnated with resin before being placed on a temporary support by means of e.g. an Automatic Tape Laying-machine). The stack can have plies with different fibre directions. The stack is thereafter moved to a forming tool for forming the stack into a structural composite part with a single curved and/or double curved shape. When forming the stack of plies over the forming tool, a force generated from a forming medium (e.g. vacuum bag or rollers) will generate shearing forces onto the stack of plies, wherein the plies will slide against each other. The +45/−45 degrees fibre direction (relative the longitudinal prolongation of the stack) plies will have a draping and the 90 degrees fibre direction plies (relative said prolongation) will have a gliding. This is performed for avoiding wrinkles in the finished formed three-dimensional structural composite part. The benefit with the gliding effect or sliding between the plies is essential, especially it will promote the avoidance of producing wrinkles.

The finished formed structural composite part is thereafter moved to an assembly and curing tool for the assembly and curing together with at least another finished formed structural composite part.

A further structural composite part can be a radius filler, i.e. a homogenous rigid resin strip reinforced with e.g. unidirectional fibres. A thermosetting material is often used as resin. Other homogenous structural composite part can be used in the assembled aircraft structure, wherein the structural composite part does not comprise laminate plies.

Today, stringers are assembled (adhered) to the inside of an aircraft shell (of a fuselage, wing etc.) for strengthening the air craft structure. Commonly is used pure epoxy and rivets (the rivets is used for securing the assembly, which is especially important regarding a wing structure). As clean tech of today tries to reach an environmental friendly approach it would be desirable if the air flow friction against the air crafts outer side could be as low as possible. However, the rivets heads projecting on the outer side are often countersink and have to be filled and levelled for making an even surface. This is costly.

Several solutions exist today for building a stack of pre-preg plies having a satisfactory strength forming a structural composite part.

US 2008/0286564 A1 describes that such composite parts can be assembled together to form aircraft structures by means of using adhesive, fasteners and/or other suitable attachment methods known in the art. The US 2008/0286564 A1 further describes a method of building the composite part by means of lying fibre layers onto each other forming a stack, wherein carbon nanotubes have been positioned between the fibre layers for strengthening the composite part being formed of the stack.

Furthermore, the document WO 2007/136755 describes a method of growing nanostructures. The nanostructures can be arranged to enhance interlaminar interactions of two plies within a composite structure and mechanically strengthen the binding between the two plies.

However, there is not shown any solution how to improve the strength of an integrated monolithic aircraft structure being built of already formed structural composite part, which being assembled together.

It is thus desirable to improve the strength of an integrated monolithic structure, i.e. an aircraft structure, being comprised of at least two assembled and together bonded structural composite parts. It is also desirable to develop already known technique wherein the shearing and tear strength between two structural composite parts will be increased.

It is also desirable to provide a cost-effective method of producing an aircraft structure, wherein the fitting in or adaptation of two adjacent structural composite parts does not need to be exact still achieving a satisfactory strength of the finished aircraft structure.

It is also an object of the present invention to provide a cost-effective production of an aircraft structure regarding the quantity of material being used for building it. An object is also to provide an aircraft with lower weight than being achieved by prior art, still maintaining the structural properties of the aircraft.

### SUMMARY OF THE INVENTION

This has been achieved by the aircraft structure defined in the introduction being characterized by the features of the characterizing part of claim 1.

Thereby a bonding between the structural composite parts is achieved which increases the shearing and tearing strength of the aircraft structure. Thereby is also achieved that the production of the aircraft structure can be made as cost-effective as possible. Due to the stronger bonding interlayer material (compared with traditional adhesive, fasteners, attachments), the aircraft structure can comprise weaker and thinner structural composite parts having lower weight and being cost-effective to produce due to the reduced application of material. Due to the strong bonding interlayer between the structural composite parts, the structural composite parts per se can thus be made weaker and thereby the whole aircraft will have lower weight and will be more cost-effective to produce compared with traditional aircraft structures assembled by means of adhesive or other fasteners, such as rivets. Prior art also uses combination of adhesive and rivets, which implies a high weight, being costly and not as strong as the present invention.

Preferably, the bonding interlayer material comprises an adhesive resin.

In such way the tolerances of matching structural composite parts to each other, and which are to be assembled, are allowed to be relatively great (i.e. their fitting tolerances have not to be close). The bonding interlayer material comprising the nanostructure is during assembly allowed to flow between the structural composite parts freely, i.e. filling the gap during assembly or before curing of the bonding interlayer material comprising the adhesive resin and the nanostructure. Since said great tolerances are allowed, the forming and assembly of the structural composite parts in the production line can be performed rapidly. No time consuming fitting has to be done, which is cost-effective in production.

Suitably, the adhesive resin is in the form of a film comprising the nanostructure. Alternatively, the adhesive resin being comprised of a paste. Suitably, the adhesive resin is made as a tape.

Preferably, the bonding interlayer material comprises a polymer material, such as polymer resins, epoxy, polyesters, vinylesters, cyanatesters, polyamids, polypropylene, BMI (bismaleimide), or thermoplastics such as PPS (poly-phenylene sulfide), PEI (polyethylene imide), PEEK (polyetheretherketone) etc., and mixtures thereof.

Alternatively, the bonding interlayer material is of a resin of the same resin material group as the pre-pregmaterial of the plies is made of. For example, if the pre-preg tapes is made of a PPS, the bonding interlayer material also preferably comprises a PPS.

Suitably, the adhesive resin is a resin which is curable in a temperature lower than the temperature at which the resin of the semi-cured structural composite parts cures.

Thereby the bonding interlayer material comprising the nanostructure will act as a distance material generating an internal pressure against the surfaces of the structural composite parts whereby e.g. a formed radius between two structural composite parts will keep a predetermined measure, thereby the air craft structure will have an uniform thickness. By the uniform thickness an increased strength of an aircraft is achieved.

Preferably, the nanostructure comprises nanofibres.

The nanofibres can thus be of carbon and are micro sized fibres arranged within the bonding interlayer material. The nanofibres preferably are embedded in the polymer material of the bonding interlayer material.

Suitably, the nanostructure comprises unidirectional nanotubes.

In this way the strength properties are optimal in one direction. Preferably, the nanotubes are oriented perpendicular against the surface of the respective structural composite part.

Alternatively, the nanostructure comprises random oriented nanotubes.

Suitably, the nanostructure comprises both random and unidirectional oriented nanotubes and/or nanofibres in a mixture.

Preferably, the structural composite parts are separately made of pre-impregnated fibre plies laid-up to each other and having different fibre orientations.

Thereby the aircraft structure will achieve an additionally increased strength.

Suitably, the bonding interlayer material applied between the adjacent structural composite parts comprises at least one end portion having a concave surface, the thickness of the end portion is greater than the thickness of the remaining part of the bonding interlayer material.

In such way is achieved also an optimal bond between a surface of a first structural composite part and a convex radius surface of a second structural composite part.

Preferably, an aircraft is assembled of at least two of said above-mentioned aircraft structures.

Thereby an aircraft is achieved which is of low weight and which is cost-effective to produce.

This has also been achieved by the method defined in the introduction being characterized by the steps of claim 9. In such way is achieved a method which can be used for a cost-effective production of an aircraft at the same time as the aircraft will have an increased strength, making it possible to save weight.

Preferably, the forming of separately at least two structural composite parts is made by pre-impregnated fibre plies, laid-up to each other and having different fibre orientations.

Preferably, the bonding interlayer material comprises an adhesive resin.

Alternatively, the bonding interlayer material is a film. Thus an effective handling of the assembly is achieved.

Suitably, the nanostructure comprises nanofibres.

Preferably, the nanostructure is arranged in the bonding interlayer material such that the orientation of the nanostructure will be perpendicular to the surfaces of the structural composite parts between which the bonding interlayer material is located.

In such way the strength in z-direction will be increased.

Suitably, at least one of the structural composite parts is fully cured before being assembled to another structural composite part.

Thereby an effective handling in production is achieved.

### BRIEF DESCRIPTION OF THE DRAWINGS

The present invention will now be described by way of example with reference to the accompanying schematic drawings, of which:

FIG. 1 illustrates an aircraft being assembled by aircraft structures comprising structural composite parts;

FIG. 2a illustrates a cross-section of an aircraft structure, i.e. a wing, comprising structural composite parts;

FIG. 2b illustrates an enlarged portion of structural composite parts in FIG. 2a;

FIG. 3a illustrates a portion of an assembly and curing tool being loaded with structural composite parts for building an aircraft structure;

FIG. 3b illustrates an enlarged portion of structural composite parts in FIG. 3a;

FIG. 4a illustrates an assembly of two structural composite parts;

FIG. 4b illustrates an assembly with another structure as a part of an aircraft structure;

FIG. 5 illustrates a portion of a further assembly and curing tool for building an aircraft structure of structural composite parts;

FIG. 6 illustrates two together assembled structural composite parts arranged face to face;

FIGS. 7a and 7b illustrate the principle of a further embodiment for optimal assembly of four structural composite parts of an aircraft structure; and

FIGS. 8a-8c illustrate different types of nanostructure and orientations.

### DETAILED DESCRIPTION

Hereinafter, embodiments of the present invention will be described in detail with reference to the accompanying drawings, wherein for the sake of clarity and understanding of the invention some details of no importance are deleted from the drawings.

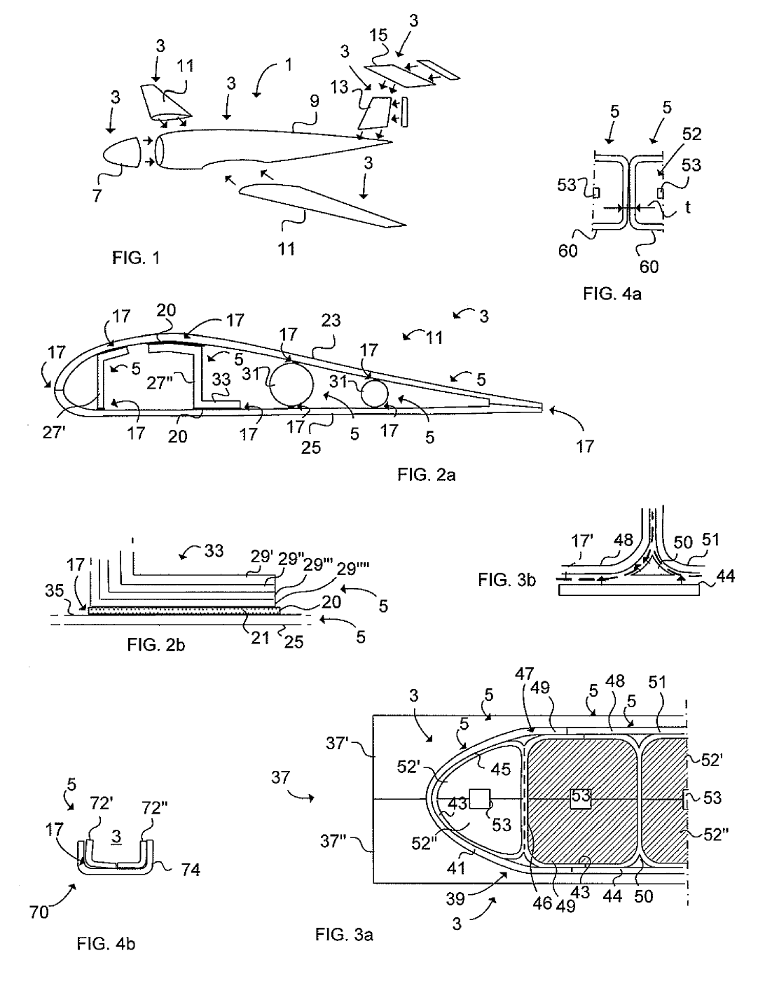

FIG. 1 illustrates an aircraft 1 being assembled of aircraft structures 3 comprising structural composite parts 5. The aircraft 1 to be assembled is illustrated and defined in this example as a vehicle which can fly in a controllable manner. The aircraft 1 consists in this example of eight aircraft structures 3, i.e. a nose cone 7, a hollow fuselage 9, left and right wings 11, a fin 13, a tail plane 15, all of which are made of composite resin. Furthermore, a rudder and an elevator are mounted to hinge at a rear part of the fin 13 and tail plane 15 respectively.

Each aircraft structure 3 is comprised of a set of said structural composite parts 5. The structural composite parts 5 of each aircraft structure 3 are bonded (connected) to each other by means of a bonding interlayer material (not shown, see FIG. 2b, reference 17). The bonding interlayer material 17 comprises a nanostructure enhanced material embedded therein. The nanostructure enhanced material being in this embodiment comprised of nanofibres (see FIG. 2b, reference 21).

FIG. 2a illustrates a cross-section of the aircraft structure 3 in FIG. 1, i.e. the wing 11, comprising different types of structural composite parts 5. An upper 23 and a lower 25 wing shell of composite resin made of pre-preg plies are bonded together by means of the bonding interlayer material 17 comprising carbon nanofibre-enhanced material 20 embedded within the bonding interlayer material 17. The bonding interlayer material 17 being comprised of epoxy filled with the nanofibres 21. The nanofibres 21 within the epoxy provide a strong bonding between the two structural composite parts (upper 23 and lower 25 wing shells).

Within the together bonded wing shells 23, 25 are further structural composite parts arranged. In the front part of the wing 11 are two wing beams 27′, 27″ of composite resin made of pre-preg plies 29′, 29″, 29′″, 29″″ arranged. Each wing beam 27′, 27″ is bonded to the inside of the wing shell 23, 25 by means of the bonding interlayer material 17 comprising the carbon nanofibre-enhanced material 20.

Each wing beam 27′, 27″ has been built in an earlier stage of the production and comprises the pre-preg plies 29′, 29″. 29′″, 29″″ which have been laid up onto each other (see FIG. 2b) according to prior art and is explained further below. In the rear part of the wing 11 homogeneous composite circular beams 31 are arranged for holding the wing shells 23,25 at a distance from each other. The circular beams 31 (also defined as structural composite parts) are made of homogeneous composite having no fibres.

FIG. 2b illustrates an enlarged portion of a flange 33 of the rear wing beam 27″. The wing beams is separately built of pre-preg plies, wherein the first pre-preg layer 29′ firstly has been positioned on a stack building table (not shown) and then the second pre-preg layer 29″ has been positioned on said first layer 29′. Thereafter a third layer 29′″ pre-preg tapes has been applied onto the second layer 29″ followed by a fourth layer 29″″. A stack of pre-preg layers has then been moved to a forming tool (not shown) for forming the stack into the desired profile in a forming step. The layers 29′, 29″, 29′″, 29″″ are fibres preimpregnated with resin. The formed structural composite part 5 (wing beam 27″) is thus formed by forming the stack of pre-preg plies. The forming is performed over the forming tool, wherein the pre-preg plies slide over each other thus for avoiding wrinkles of the stack. In this embodiment, there is no desire to improve the strength between the pre-preg plies in the stack to be formed, since wrinkles in such case may appear during the forming of the stack into the structural composite part.

Flexibility in forming is achieved since the stack can be placed at the forming tool with any of its sides toward the forming tool. This implies a cost effective production. In FIG. 2b is shown that the last laid pre-preg ply 29″″ of the structural composite part 5 (rear wing beam 27″) is nearest the lower shell 25.

The formed structural composite part 5 (here the rear wing beam 27″) is semi-cured and thereafter moved to an aircraft structure assembly station (a wing assembly station, not shown).

FIG. 2b is in an over-explicit view showing also the nanostructure in the form of nanofibres 21 applied in the bonding interlayer material 17 between the wing shell 25 and the rear wing beam 27″. The nanofibres 21 are unidirectional positioned within the bonding interlayer material 17 and are oriented perpendicular against the inner surface 35 of the lower wing shell 25. In this way the strength properties are optimal in one direction, i.e. the shearing strength in the interface between the structural composite parts 5 is optimal.

FIG. 3a illustrates a portion of an aircraft structure assembly and curing tool 37. The tool 37 being loaded with structural composite parts 5, each being earlier formed over by hand over forming tools. The tool 37 loaded with the parts 5 for building the aircraft structure 3, in this case a landing gear door 39. The structural composite parts 5 being assembled are: a nose cap 41 of reinforced resin being bonded to an upper and lower shell inner surface 43, a structural nose beam 45 of composite being arranged and bonded to the web 46 of an adjacent first structural U-beam 47, the flanges 49 of which being bonded to the inner surface 43 of the shell 44 and bonded to the flange edges of a second structural U-beam 48, a third structural U-beam 51 having its web bonded to the web of the second structural U-beam 48, etc. The upper and lower shells 44 are bonded in the rear part (not shown) of the landing gear door 39. The structural composite parts 5 being comprised of also resin radius fillers 50, one of which is in more detail shown in FIG. 3b.

One of the radius filler 50 is prolonged and comprises a nanostructure (not shown) in the periphery of the radius filler, i.e. within the area of the radius filler which is facing the structural composite parts 5 and the bonding interlayer material 17. In thus way the connection between the structural composite parts 5 within a section, where the merging of curved corners of the structural composite parts prevails, will be even stronger. The nanostructure is thus located in the periphery of the composite radius filler 50 for reinforcement of an interface area 15 between the composite radius filler 50 and the structural composite parts 5. The prolongation of the nanostructure is perpendicular to the surfaces of the each other facing corners of the structural composite parts 5. The radius filler plane corresponding with the shown triangular cross section of the radius filler 50.

The structural composite parts 5 and the bonding interlayer material 17 comprising epoxy and nanotubes (not shown), are positioned in the tool 37 consisting of an upper 37′ and lower 37″ forming tool part including heating elements (not shown) for increasing the temperature of the structural composite parts 5 and the bonding interlayer material 17 for a proper curing of the bonding interlayer material 17 comprising the nanotubes and a proper curing and bonding of the semi-cured structural composite parts 5. Interior holding-on tools 52 are placed within the nose beam 45 and the U-beams 47, 48, 51 for achieving a pressure from inside. Each interior holding-on tool 52 can be divided into parts 52′, 52″ by releasing a wedge 53 arranged for keeping the parts 52′, 52″ together.

FIG. 3b illustrates an enlarged portion of the aircraft structure 3 in FIG. 3a and the structural composite parts 5 comprising also the radius filler 50 made of resin and the positioning of the structural composite parts 5 to each other with a bonding interlayer material film 17′ positioned between the structural composite parts 5. The bonding interlayer material film 17′ comprises the nanostructure in the form of carbon nanotubes. The radius filler 50 is positioned between curved surfaces of two adjacent U-beams 48, 51 and the lower shell 44.

The bonding interlayer material is a film adhesive resin, which cures in a temperature lower than the temperature at which the resin of the structural composite parts 5 cures. Thereby the bonding interlayer material 17 comprising the nanostructure will act as a distance material and holding-on tool generating an internal pressure against the surfaces of the structural composite parts 5, whereby e.g. a formed radius filler 50, as shown in FIG. 3b, arranged between two structural composite parts 5 will keep a predetermined measure. I.e. the structural composite part (radius filler 50) to be cured will adapt its form to the actual form of the hollow space created by the U-beams and shell.

The structural properties of the bonding interlayer material 17 comprising the nanostructure enhanced material 19 means that a strong bonding between the structural composite parts 5 is achieved, which increases the shearing and tearing strength of the aircraft structure 3. Thereby is also achieved that the production of the aircraft structure 3 can be made as cost-effective as possible. Due to the stronger bonding interlayer material 17 (compared with traditional adhesive, fasteners, attachments), the aircraft structure 3 can comprise weaker and thinner structural composite parts 5 having lower weight and being cost-effective to produce due to the reduced application of material. Due to the strong bonding interlayer material 17 arranged between the structural composite parts 5, the structural composite parts 5 can thus be made weaker and thereby the whole aircraft 1 will have lower weight and will be more cost-effective to produce compared with traditional aircraft structures assembled by means of adhesive or other fasteners, such as rivets. Prior art also uses combinations of adhesive and rivets, which implies a high weight, being costly and will be weaker.

In FIG. 4a is shown an assembly of two structural composite parts 5 or U-beams 60 for building a fin 13 (see FIG. 1). The adhesive resin of the bonding interlayer material 17, comprising graphite nanofibres, is also a resin which is curable in a temperature lower than the temperature at which the resin of the beforehand provided U-beams 60 cures. The, in the first step hardened, bonding interlayer material 17 will thus act as a distance material generating an internal pressure against the surfaces of the U-beams 60 having accidently produced irregular wall thickness. When the internal holding-on tools co-operate for achieving a distance t between their tool surfaces, the U-beam's 60 semi-cured webs of resin will adapt their thickness to the distance t. The aircraft structure 3 will thus have a uniform web thickness corresponding to the distance t in this case. By the uniform thickness an increased strength is achieved, since no points of fracture thereby will be present.

FIG. 4b illustrates a U-beam 70 of an aircraft structure 3 which has two positioned L-profiles 72′, 72″ adjacent the inner side of an outer U-beam 74. The L-profiles 72′, 72″ are bonded to the outer U-beam 74 by means of epoxy comprising nanofibres, which are oriented irregularly, wherein the fibres directions are different. As being shown in FIG. 4b the L-profile 72′ is mounted slightly inclined to the outer U-beam 74 due to a quick mounting and a not exact fit. However, a relatively thick bonding interlayer material 17, comprising nanofibres embedded in the epoxy, will flow out during the assembly (before curing) and fill the gap being created by the eventually bad fit, thus ensuring a proper strength. Thereby a high strength of the bond between the structural composite parts 5 is ensured at the same time as the aircraft structure 3 can be produced time-effective.

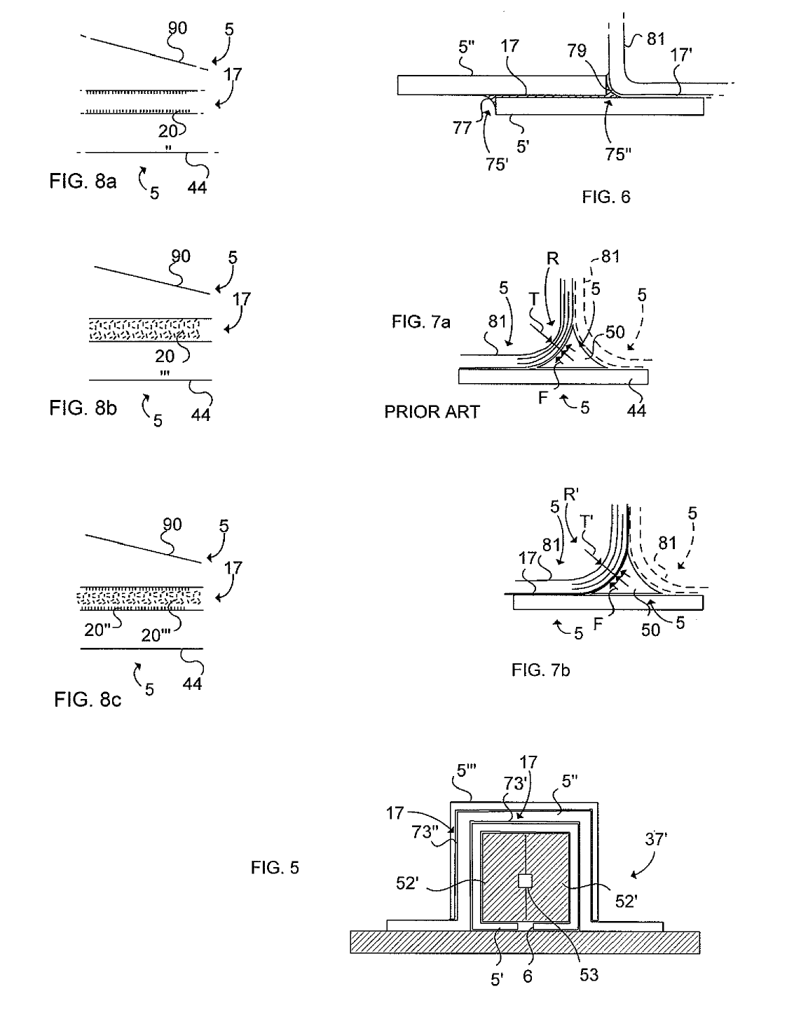

FIG. 5 illustrates a portion of a further assembly and curing tool 37′. Two inner male forming tools 52′ are placed within a hollow structural composite part 5′ (being provided with a slit 6). Onto the hollow structural composite part 5′ is placed a hat profile 5″ comprising flanges resting on a tool surface. An outer U-beam blank 52′″ (also defined as a structural composite part) is placed over the hat profile 5″. Between the hat profile 5″ and the outer U-beam 5′″ and the hollow structural composite part 5′ is applied a first 73′ and a second 73″ film made of the bonding interlayer material of epoxy and nanotubes for bonding the respective structural composite part 5 to each other. The assembly and curing tool 37′ is then placed in an autoclave (not shown) for curing the assembly of the parts 5′, 5″, 5′″. After the curing in the autoclave, the assembly is removed from the tool 37′ and moved to a next production site (not shown) to be bonded to another structural composite part 5 for building an aircraft structure 3.

A method of producing an aircraft structure 3 comprising structural composite parts 5′. 5″, 5′″ assembled together to form said aircraft structure 3 is thus achieved. The bonding interlayer material 17 is located between the together assembled structural composite parts and comprises a nanostructure embedded therein. The bonding interlayer material 17 is provided by a mixture of resin and nanotubes. The three structural composite parts 5′, 5″, 5′″ are formed in a preceding production step separately. They are made of pre-impregnated fibre plies (not shown) which are laid-up onto each other and having different fibre orientations. Each structural composite part 5′, 5″, 5′″ is then moved to an assembly station. At the assembly station the separately formed structural composite parts 5′, 5″, 5′″ are put together with the bonding interlayer material 17 positioned between the structural composite parts 5′, 5″, 5′″ in areas where a bond between the structural composite parts 5′, 5″, 5′″ is preferred. The assembly and curing tool cures the assembled structural composite parts 5′, 5″, 5′″ and the bonding interlayer material 17 at the same time, for achieving said bonding between the structural composite parts. When the curing is finished, the cured aircraft structure 3 is moved from the assembly and curing tool. In such way is achieved a method which can be used for a cost-effective production of an aircraft 1 at the same time as the aircraft 1 will have an increased strength, making it possible to save weight.

FIG. 6 illustrates two together assembled structural composite parts 5′, 5″. The bonding interlayer material 17 is applied between the two adjacent structural composite parts 5′, 5″ overlapping each other. The bonding interlayer material 17 comprises a first 75′ and second end portion 75″ each having a concave surface 77. The bonding interlayer material 17 is thicker within the area of the end portions 75′, 75″ than the remaining bonding interlayer material 17 (which bonds the both structural composite parts 5′, 5″ together where the parts are assembled face to face). This thicker bonding interlayer material 17 at respective end portion 75′, 75″ is provided with the concave surface 77 for distribution of the shearing forces from one structural composite part 5′ to the other 5″ in an optimal way. In such way is achieved also that an optimal bond between a surface of a first structural composite part 5′ and a convex radius surface 79 of a curved second structural composite part 81 can be achieved by means of a second bonding interlayer material 17′.

FIGS. 7a and 7b illustrate the principle of a further embodiment for optimal assembly of four structural composite parts 5 of an aircraft structure 3. In FIG. 7a is shown an assembly of a composite shell 44, a composite radius filler 50, two L-profiles 81 facing each other being bonded to each other by means of a prior art bonding interlayer material. The radius filler 50 is made structural by filling the resin of the radius filler 50 with carbon fibres (not shown). The function of the radius filler 50 is to enhance the strength of the aircraft structure 3. During the forming and curing of the assembly of FIG. 7a, the vacuum pressure of a forming tool will compress pre-preg plies of the L-profiles 81 with a force F, within their radii areas R, making the wall thickness T thinner within these areas. This is caused by the higher pressure generated within the radius area R. In FIG. 7b is shown an embodiment according to the present invention wherein the bonding interlayer material (not shown) comprises a film adhesive resin enclosing nanofibres, which resin is curable in a temperature lower than the temperature at which the resin of the structural composite parts cures. Thereby the bonding interlayer material 17 comprising the nanostructure will be hard enough to act as a tool surface holding-on the pressure acting onto the radii R′ of the L-profiles, still not yet being cured. The bonding interlayer material thus acts as a distance material during assembly generating an internal pressure against the surfaces of said radii areas R, whereby the formed radius between two structural composite parts 5′, 5″ will keep a predetermined measure. Thereby the aircraft structure 3 will have a uniform thickness T′. By the uniform thickness an increased strength is achieved.

FIGS. 8a-8c illustrate different types of nanostructure and orientations. FIG. 8a illustrates a bonding interlayer material 17 of epoxy comprising nanofibres 20″ being oriented unidirectional in z-direction (i.e. perpendicular against the surfaces of the structural composite parts 5 to be assembled, a stringer 90 and the lower shell 44). In FIG. 8b is shown random oriented nanotubes 20″′ in a bonding interlayer material 17. In FIG. 8c is shown random oriented nanotubes 20″′ in a central volume of the bonding interlayer material 17 and unidirectional nanotubes 20″ in the interface between the bonding interlayer material 17 and the structural composite part 5.

The present invention is of course not in any way restricted to the preferred embodiments described above, but many possibilities to modifications, or combinations of the described embodiments, thereof should be apparent to a person with ordinary skill in the art without departing from the basic idea of the invention as defined in the appended claims. Of course, also other types of structural composite parts, such as stringers, sub spars, shear-ties etc., may be assembled to a shell or to another structural composite part. The structural composite part can be either semi-cured or cured before being assembled or attached to another structural composite part for producing the aircraft structure. The orientation of the nanostructure in the bonding interlayer material can be unidirectional and/or random oriented and the nanostructure can consist of nanotubes and/or nanofibres and/or nanowires. The unidirectional direction can be in z-, x-, y- directions, either solely or in combination. The nanostructure material can be any of the groups; carbon, ceramic, metal, organic, cellulosic fibres.

1. An aircraft structure comprising structural composite parts (5) assembled together to form said aircraft structure (3); said aircraft structure (3) further comprises a bonding interlayer material (17) provided to bond said structural composite parts (5) to each other, characterized by that said bonding interlayer material (17) comprises a nanostructure enhanced material (20, 21).

2. The aircraft structure according to claim 1, wherein the bonding interlayer material (17) comprises an adhesive resin.

3. The aircraft structure according to claim 2, wherein the adhesive resin is a resin which is curable in a temperature lower than the temperature at which a semi-cured resin of the structural composite parts (5) cures.

4. The aircraft structure according to claim 2 or 3, wherein the adhesive resin is a film.

5. The aircraft structure according to any of claims 1 to 4, wherein the nanostructure comprises nanofibres (20).

6. The aircraft structure according to claim any of claims 1 to 4, wherein the nanostructure comprises unidirectional nanotubes.

7. The aircraft structure according to claim any of claims 1 to 4, wherein the nanostructure comprises random oriented nanotubes.

8. The aircraft structure according to claim any of the preceding claims, wherein the structural composite parts (5) are separately made of pre-impregnated fibre plies (29) laid-up to each other and having different fibre orientations.

9. The aircraft structure according to claim any of the preceding claims, wherein the bonding interlayer material (17) applied between the adjacent structural composite parts (5) comprises at least one end portion (75)′ having a concave surface (77), the thickness of the end portion (75′) is greater than the thickness of the remaining part of the bonding interlayer material (17).

10. An aircraft being assembled of at least two of the aircraft structures (3) according to any of the preceding claims.

11. A method of producing an aircraft structure (3) comprising structural composite parts (5) assembled together to form said aircraft structure (3), said aircraft structure (3) further comprises a bonding interlayer material (17) to bond said structural composite parts (5) to each other, the bonding interlayer material (17) is located between the together assembled structural composite parts (5) and comprises a nanostructure enhanced material embedded therein, the method is characterized by the steps of:
providing said bonding interlayer material (17);
forming separately at least two structural composite parts (5);
assembling the separately formed structural composite parts (5) and locating said bonding interlayer material (17) between the structural composite parts (5) being assembled together;
curing the assembled structural composite parts (5) and the bonding interlayer material (17) in a curing tool (37); and
removing the finished cured aircraft structure (3) from the curing tool.

12. The method according to claim 11, wherein the bonding interlayer material (17) comprises an adhesive resin.

13. The method according to claim 11 or 12, wherein the bonding interlayer material (17) is a film.

14. The method according to any of claims 11 to 13, wherein the nanostructure comprises nanofibres (21).

15. The method according to any of claims 11 to 14, wherein the nanostructure is arranged in the bonding interlayer material (17) such that the orientation of the nanostructure will be perpendicular to the surfaces of the structural composite parts (5) between which the bonding interlayer material (17) is located.

16. The method according to any of claims 11 to 15, wherein at least one of the structural composite part (5) is fully cured before being assembled to another structural composite part.
